(19) United States
(12) Patent Application Publication
(10) Pub. No.: US 2025/0244528 A1
(43) Pub. Date: Jul. 31, 2025

(54) PHOTONIC INTEGRATED CIRCUITS TO GLASS SUBSTRATE BONDING

(71) Applicant: Applied Materials, Inc., Santa Clara, CA (US)

(72) Inventors: Zijiao YANG, Santa Clara, CA (US); Jinxin FU, Fremont, CA (US); Hans-Juergen SCHMIDTKE, Santa Clara, CA (US); Robert BLUM, Santa Clara, CA (US)

(21) Appl. No.: 18/732,211

(22) Filed: Jun. 3, 2024

Related U.S. Application Data
(60) Provisional application No. 63/627,591, filed on Jan. 31, 2024.

(51) Int. Cl. G02B 6/12

(52) U.S. Cl. CPC G02B 6/12004

(57) ABSTRACT

Embodiments described herein also relate to co-packaged optical and electrical device. The co-packaged optical and electrical device include a package substrate, an electrical or opto-electrical chip disposed on the package substrate, a photonic integrated interconnect unit disposed on the package substrate, a plurality of interconnects, and a plurality of optical structures. The photonic integrated interconnect unit includes a photonic integrated circuit (PIC) including a PIC waveguide. The plurality of interconnects connect the electrical or opto-electrical chip to the photonic integrated interconnect unit. The interconnects are formed on or in the package substrate. The plurality of optical structures are configured to connect the photonic integrated interconnect unit to a fiber optic cable. The plurality of optical structures include a substrate waveguide formed on or in the package substrate. The substrate waveguide is coupled to the PIC waveguide via evanescent coupling.

### CROSS-REFERENCE TO RELATED APPLICATIONS

This application claims benefit of U.S. provisional patent application Ser. No. 63/627,591, filed Jan. 31, 2024, which is herein incorporated by reference.

### BACKGROUND

### Field

Embodiments of the present disclosure generally relate to silicon photonic integrated circuits and co-packaged optical silicon photonic devices. More particularly, the present disclosure pertains to apparatus for co-packaged optical silicon photonic devices and methods of fabricating optical structures for optical silicon photonic devices.

### Description of the Related Art

With increasing data traffic network demands, networking companies previously using the traditional copper cable for communication have sought out more efficient solutions that could be deployable on a massive scale. Today, optical fiber technologies dominate the long-distance communications space. Networking companies have gradually been transitioning to using optical fibers to transmit data across great distances. With the use of optical fibers, data is transmitted as photons at the speed of light at super-high frequencies, thereby allowing for higher data volume transmissions.

Along with data traffic network demand increases, there is also a demand for ever-increasing data rates in electronic systems and communications. One area of improvement that can help the semiconductor industry as it balances the challenges of ever-increasing integrated circuit operating speeds and chip solutions (e.g., to address increasing data traffic networks demands) is improvements in interconnect speeds. The typical electrical interconnect solution between transistors on traditional integrated circuits continues to rely on electrons through copper wiring. Potential issues with the use of copper wiring for communication and data transmission in general are infrared (IR) heating and interactions between electrons traveling through such wires with other atoms, which slow the electrons down and contribute to signal loss. There is therefore a motivation to reduce the use and length of copper interconnects and wires on solutions for communication and data transfer technologies. One approach to minimize the use of copper interconnects is co-packaged multi-chip modules in which a single package substrate includes multiple integrated circuit devices assembled closely together. Such multi-chip modules have been explored, but use of typical multi-chip modules still largely rely on copper wiring to transmit data to and from the printed circuit boards of the multi-chip modules.

Another approach to minimize the use of copper wiring in electronic communication systems is the integration with optical communication system technologies which have proven to be more advantageous than copper for communication and data transmission due to lower length-dependent and data-rate-dependent signal loss. More recently, optical components are being integrated on silicon (Si) substrates for fabricating large-scale silicon photonics integrated circuits that co-exist with micro-electronic chips. Optical communications technologies typically involve different materials and fabrication processes than electronic communications technologies. However, silicon photonics technologies have brought optical communications technologies together with electronics technologies based on a common material platform. With the use of an optical transceiver, a received optical signal can be converted to an electrical signal capable of being processed by an integrated circuit, or the processed electrical signal can be converted to an optical signal to be transmitted via an optical fiber.

Accordingly, what is needed in the art are improved co-packaged optical silicon photonic devices and methods of fabrication.

### SUMMARY

Embodiments of the present disclosure generally relate to silicon photonic integrated circuits and co-packaged optical silicon photonic devices. More particularly, the present disclosure pertains to apparatus for co-packaged optical silicon photonic devices and methods of fabricating optical structures for optical silicon photonic devices.

In one embodiment, co-packaged optical and electrical device is disclosed. The co-packaged optical and electrical device include a package substrate, an electrical or opto-electrical chip disposed on the package substrate, a photonic integrated interconnect unit disposed on the package substrate, a plurality of interconnects, and a plurality of optical structures. The photonic integrated interconnect unit includes a photonic integrated circuit (PIC) including a PIC waveguide. The plurality of interconnects connect the electrical or opto-electrical chip to the photonic integrated interconnect unit. The interconnects are formed on or in the package substrate. The plurality of optical structures are configured to connect the photonic integrated interconnect unit to a fiber optic cable. The plurality of optical structures include a substrate waveguide formed on or in the package substrate. The substrate waveguide is coupled to the PIC waveguide via evanescent coupling.

In another embodiment, a co-packaged optical and electrical device is disclosed. co-packaged optical and electrical device includes a package substrate, an integrated electrical or opto-electrical chip disposed on the package substrate, a photonic integrated interconnect unit disposed on the package substrate, and a plurality of optical structures. The integrated electrical or opto-electrical chip includes an electrical or opto-electrical chip disposed on the package substrate, a first photonic integrated circuit (PIC) comprising a first PIC waveguide, and a second PIC comprising a second PIC waveguide. The plurality of optical structures are configured to connect the photonic integrated interconnect unit to a fiber optic cable. The plurality of optical structures include a substrate waveguide formed on or in the package substrate. The substrate waveguide is coupled to the first PIC waveguide and the second PIC waveguide via evanescent coupling.

In yet another embodiment, co-packaged optical and electrical device is disclosed. The co-packaged optical and electrical device includes a package substrate, a photonic integrated interconnect unit disposed on the package substrate, an electrical or opto-electrical chip disposed on the photonic integrated interconnect unit, and a plurality of optical structures. The photonic integrated interconnect unit includes a photonic integrated circuit (PIC) including a PIC waveguide. The PIC waveguide is disposed in the PIC. The plurality of optical structures are configured to connect the photonic integrated interconnect unit to a fiber cable, the plurality of optical structures a substrate waveguide formed on or in the package substrate. The substrate waveguide is coupled to the PIC waveguide via evanescent coupling.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a perspective view of a portion of exemplary co-packaged optical and electrical device, according to an embodiment.

FIG. 2 illustrates top views of the photonic integrated interconnect unit, according to an embodiment.

FIG. 3A illustrates a cross-sectional side view of the co-packaged optical and electrical device, according to an embodiment.

FIG. 3B illustrates a top view of the co-packaged optical and electrical device, according to an embodiment.

FIG. 3C illustrates a photonic integrated circuit (PIC), according to an embodiment.

FIG. 3D illustrates a glass packaging substrate, according to an embodiment.

FIG. 3E illustrates a silicon packaging substrate, according to an embodiment.

FIG. 4A illustrates a cross-sectional side view of the co-packaged optical and electrical device with a top mounted electrical or opto-electrical chip, according to an embodiment.

FIG. 4B illustrates a top view of the co-packaged optical and electrical device with a top mounted electrical or opto-electrical chip, according to an embodiment.

FIG. 5A illustrates a cross-sectional side view of the co-packaged optical and electrical device with an integrated electrical or opto-electrical chip, according to an embodiment.

FIG. 5B illustrates a top view of the co-packaged optical and electrical device with an integrated electrical or opto-electrical chip, according to an embodiment.

FIG. 6 illustrates a flow diagram of a method for fabricating a portion of a package substrate, according to an embodiment.

FIGS. 7A-7E illustrate schematic, cross-section views of a portion of the package substrate during the method of FIG. 6, according to an embodiment.

FIG. 8 illustrates a flow diagram of a method for fabricating a portion of a package substrate, according to an embodiment.

FIGS. 9A-9F illustrate schematic, cross-section views of a portion of the package substrate during the method of FIG. 8, according to an embodiment.

FIG. 10 illustrates a flow diagram of a method for fabricating a portion of a package substrate, according to an embodiment.

FIGS. 11A-11E illustrate schematic, cross-section views of a portion of the package substrate during the method of FIG. 10, according to an embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to silicon photonic integrated circuits and co-packaged optical silicon photonic devices. More particularly, the present disclosure pertains to an apparatus for co-packaged optical silicon photonic devices and methods of fabricating optical structures for optical silicon photonic devices.

As used herein, the term “about” refers to a +/−10% variation from the nominal value. It is to be understood that such a variation can be included in any value provided herein.

In various embodiments of the present disclosure, layers or other materials are referred to as being deposited. It is understood that the deposition of these materials can be performed using any conventional methods used in semiconductor manufacturing, such as, but not limited to, chemical vapor deposition (CVD), atomic layer deposition (ALD), physical vapor deposition (PVD), electroplating, electroless plating, the selective deposition of any of the above, combinations of the above, and any other suitable method. It is to be understood that when a method operation is described herein as depositing a material in two or more separate locations, the depositions can occur simultaneously, or the material can be deposited in separate sub operations.

In various embodiments of the present disclosure, layers or other materials are referred to as being etched. It is understood that the etching of these materials can be performed using any conventional methods used in semiconductor manufacturing, such as, but not limited to, reactive ion etching (RIE), dry etching, wet etching, or laser ablation, combinations of the above, and any other suitable method of removing material. It is to be understood that when a method operation is described herein as etching two or more types of materials, the etching can occur simultaneously with the same etching process, or the etching can be performed in separate sub-operations using different etching processes. For example, an operation describing etching a metal and a dielectric includes a first etching sub operation using a first etching process that etches the metal, and the operation further includes a second etching sub operation using a second etching process that etches the dielectric.

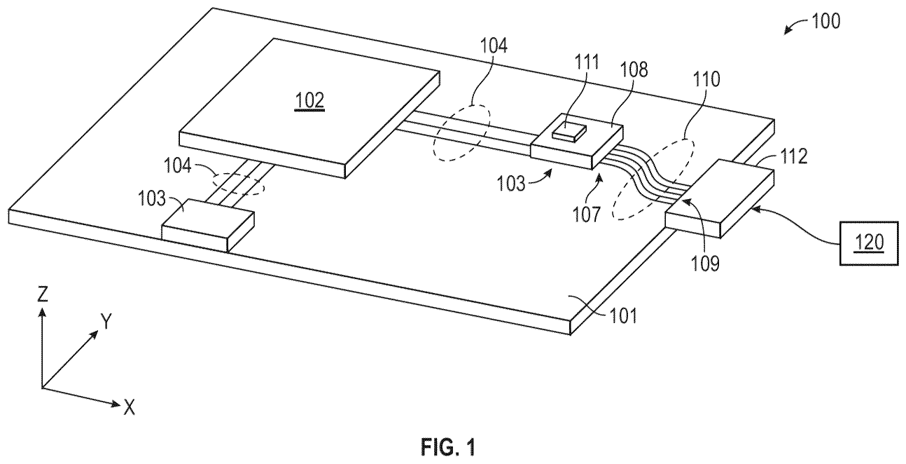

FIG. 1 illustrates a perspective view of a portion of a co-packaged optical and electrical device 100. The co-packaged optical and electrical (opto-electrical) device 100 comprising an electrical or opto-electrical chip 102 connected via a plurality of optical waveguide or electrical trace interconnects (e.g., interconnects 104) to a photonic integrated interconnect unit 103. The electrical or opto-electrical chip 102, interconnects 104, and the photonic integrated interconnect unit 103 are formed integral with (e.g., contained within) or disposed on (e.g., in contact with a surface of) a package substrate 101 (e.g., an interposer). In some embodiments, the package substrate 101 is disposed on a printed circuit board (PCB) or other base substrate. The PCB is a composite material made from woven fiberglass with an epoxy resin fiber. The other base substrate includes glass or silicon. In some embodiments, the electrical or opto-electrical chip 102 may include any high-density chip having a high I/O pin count. In one example, the high-density chip has between 100 and 2000 I/O pins or up to and greater than 2000 I/O pin counts. Examples of electrical or opto-electrical chips 102 include but not limited to data center SWITCH chips, artificial intelligence (AI) chips, and the like.

The photonic integrated interconnect unit 103 includes a fiber connector region configured to be coupled to a fiber connector 112 for removably connecting a fiber optic cable 120 to the photonic integrated interconnect unit 103. In an embodiment, the fiber optic cable 120 may be plugged into the fiber connector 112 to operably connect the fiber optic cable 120 to the co-packaged optical and electrical devices 100. In an embodiment, the photonic integrated interconnect unit 103 is configured for connecting fiber optic cables 120 including, but not limited to, single-mode fiber optic cables having 9 micron fiber core diameters. The fiber connector 112 may further include a plurality of optical fibers 112A to operably connect fiber optic cables 120 having between 1 to 74 fiber cores, 74 to 148 fiber cores, and up to and greater than 148 fiber cores to the photonic integrated interconnect unit 103.

In an embodiment, the photonic integrated interconnect unit 103 in the set of co-packaged electrical and optical devices 100 is configured to transmit signals between the electrical or opto-electrical chip 102 and the fiber optic cable 120 connected to the photonic integrated interconnect unit 103. The photonic integrated interconnect unit 103 includes a plurality of optical structures 110₁-110_{N} (collectively optical structures 110), an optical transceiver integrated circuit (e.g., silicon photonics (SiPho) chip 108), and the fiber connector 112. The plurality of optical structures 110₁-110_{N} are formed integral with (e.g., contained within) or disposed on (e.g., in contact with the surface of) the package substrate 101. The SiPho chip 108 is mounted on the package substrate 101 and coupled to the plurality of optical structures 110₁-110_{N} at a first interface 107. The SiPho chip 108 is mounted to the package substrate 101 using a hybrid bonding process. The hybrid bonding process is used to bond two interfaces, where the interfaces include both metal and dielectric materials. The hybrid bonding process includes a pretreatment (e.g., chemical mechanical processing, wet clean, plasma treatment, wetting, etc.) high precision alignment, bonding, and annealing. The hybrid bonding process enables passive optical alignment, which in turn enables high scalability, high speed electrical connections, low loss optical coupling, and high volume manufacturing during the process of adding the SiPho chips 108 to co-packaged electrical and optical devices 100. The fiber connector 112 is connected to both the package substrate 101 and the plurality of optical structures 110₁-110_{N} at a second interface 109.

The plurality of optical structures 110₁-110_{N} and SiPho chip 108 being formed integral with or mounted on the package substrate 101 enables the removal of a silicon (Si) interposer commonly used in co-packaged optical and electrical devices. Removing the Si interposer simplifies manufacturing and reduces warp or bow associated with chip-to-substrate bonding, as a bond (i.e., the bond between the Si interposer and the package substrate 101) is eliminated. Furthermore, the Si interposer is an expensive and low yield component, requiring the formation of vias and substrate thinning, further increasing cost.

In an embodiment, the SiPho chip 108 in the photonic integrated interconnect unit 103 is a photonic integrated circuit (PIC). The SiPho chip 108 operates to convert electrical signals to optical signals, and vice versa. The plurality of optical structures 110₁-110_{N} in the photonic integrated interconnect unit 103 operate to transmit optical signals between the SiPho chip 108 and the fiber connector 112, and interconnects 104 operate to transmit electrical or optical signals between the photonic integrated interconnect unit 103 (specifically, the SiPho chip 108) and the electrical or opto-electrical chip 102. Interconnects 104 can include metal traces that are formed within the package substrate 101, which in some embodiments can include metal traces formed in a printed circuit board (PCB) substrate or metal traces formed within a plurality of redistribution layers (e.g., dielectric containing layers) formed over a solid core substrate (e.g., silicon or glass core substrate).

The photonic integrated interconnect unit 103 may optionally further include one or more electronic physical layer (phy) chips 111 that are coupled to the SiPho chip 108. The electronic phy chip 111 is generally used to assist with operations performed by an optical chip. In some embodiments, the electronic phy chip 111 is operably connected to the SiPho chip 108 to assist the SiPho chip 108 with various electrical functions. As shown, the electronic phy chip 111 may be mounted on top of the SiPho chip 108 and thereby directly connected to the SiPho chip 108. Further, the electronic phy chip 111 can be mounted on or embedded in the package substrate 101 and connected to the SiPho chip 108 through interconnects 104.

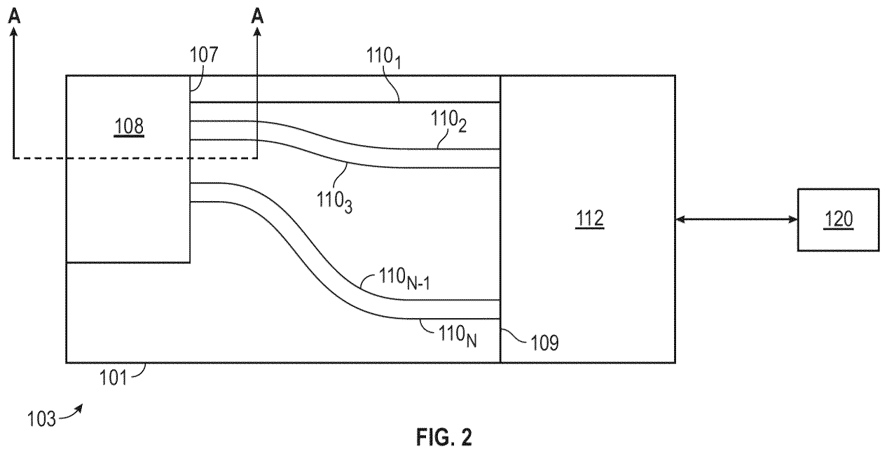

FIG. 2 illustrates top views of the photonic integrated interconnect unit 103. In some embodiments, the photonic integrated interconnect unit 103 includes the SiPho chip 108 mounted at one area of the package substrate 101, the fiber connector 112 connected at another area of the package substrate 101, and the plurality of optical structures 110₁-110_{N} extending between the SiPho chip 108 and the fiber connector 112. In an embodiment, each of the plurality of optical structures 110₁-110_{N} include a light transmitting region for transmitting light in either direction between the first interface 107 and the second interface 109. The light being transmitted through the plurality of optical structures 110₁-110_{N} can be either received from one or more of a plurality of waveguides of the SiPho chip 108 or received from one or more of a plurality of optical fibers within the fiber connector 112 that a light signal source is in communication with during use. The SiPho chip 108 is typically configured to receive (e.g., detect) light transmitted through the optical structures 110₁-110_{N} can also emit (e.g., transmit) light into the optical structures 110₁-110_{N} to communicate with external devices connected through the fiber connector 112. The SiPho chip 108 can be configured to transmit light into the optical structures 110₁-110_{N} by at least the use of light emitters integrated into SiPho chip 108, or by use of light emitters that are external to the package substrate 101. In the case where the light emitters are external to the package substrate 101, the light is delivered to SiPho chip 108 via the optical structures 110₁-110_{N} and then modulated by the SiPho chip 108 to create a transmit signal that is provided to the optical structures 110₁-110_{N}.

In some embodiments, which can be combined with other embodiments described herein, the plurality of optical structures 110₁-110_{N} are formed directly on a surface of the package substrate, formed indirectly on the surface of the package substrate 101 (e.g., formed on an intermediate layer that is formed directly on the package substrate 101), or are integral with (e.g., contained within) the package substrate 101. Each of the plurality of optical structures 110₁-110_{N} in the photonic integrated interconnect unit 103 may be formed by one of various methods described herein.

In some embodiments, which can be combined with other embodiments described herein, the light transmitting region within each of the plurality of optical structures 110₁-110_{N} may have the same cross-sectional dimensions, such as height and width. In some embodiments, which can be combined with other embodiments described herein, the light transmitting region within at least one of the plurality of optical structures 110₁-110_{N} may have at least one different cross-sectional dimensions, such as one of height and width, from the dimensions of the other plurality of optical structures 110₁-110_{N} within the package substrate 101. In some embodiments, which can be combined with other embodiments described herein, the light transmitting region within each of the plurality of optical structures 110₁-110_{N} may have the same refractive index. In another embodiment, which can be combined with other embodiments described herein, the light transmitting region within at least one of the plurality of optical structures 110₁-110_{N} may have a different refractive index or multiple different refractive indexes or a gradual gradation of refractive indexes or other index varying structures when compared with the rest of the plurality of optical structures 110₁-110_{N} within the package substrate 101.

In some aspects, the number of optical structures 110₁-110_{N} formed in the package substrate 101 is dependent on the number of waveguides in the SiPho chip 108 needing to be connected, which may also correspond with the number of fiber connections needing to be connected to the opto-electrical chip 102. In an embodiment, the opto-electrical chip 102 may comprise seventy-two (72) fiber connections such that seventy-two (72) corresponding interconnects 104 extend from the opto-electrical chip 102 and connect to seventy-two (72) corresponding fibers and waveguides in the SiPho chip 108 of the photonic integrated interconnect unit 103. To appropriately connect the SiPho chip 108 to the fiber connector 112 via the plurality of optical structures 110₁-110_{N} in the package substrate 101, seventy-two (72) corresponding optical structures 110₁-110_{N} are formed on or integral with the package substrate 101. In this example, N as shown in FIG. 2 will equal 72, and thus the plurality of optical structures 110₁-110_{N} are spaced apart in the X-Y plane from one edge of the package substrate 101 to the other edge of the package substrate 101. In this example, optical structure 110₁ is positioned near the top most edge and optical structure 11072 would be positioned closest to the bottom most edge of the package substrate 101. As discussed further below, the optical structures 110₁-110_{N} are spaced apart and separated by a material that has different optical properties, such as index of refraction (n), than the light transmitting portions of the optical structures 110₁-110_{N}.

The plurality of optical structures 110₁-110_{N} are generally sized and configured to appropriately connect to the plurality of waveguides within the SiPho chip 108. In some embodiments, the plurality of waveguides at the output of the SiPho chip 108, or portion that is to communicate with the optical structures, have a core with a height dimension that is about 1 micron (μm) in cross-sectional size. In one configuration, the output of the SiPho chip 108 has a square or rectangular shaped cross-section that has at least one dimension that is equal to about 1 μm in length. For example, a square cross-section of a waveguide of the SiPho chip 108 may have a core that is 1 μm height and width. Light transmitted to and from the SiPho chip 108 would thus be transferred through the 1 micron waveguides of the SiPho chip 108.

In contrast, light transmitted to and from the fiber optic cable 120 through the fiber connector 112 can have a different form factor, such as having a core cross-sectional dimension of about 9 μm in size. For example, the fiber connector 112 may have a square, rectangular or circular cross-section with a core having a height dimension that is about 9 μm in size. As such, in some embodiments, each of the plurality of optical structures 110₁-110_{N} are formed such that light propagating through the plurality of optical structures 110₁-110_{N} between the SiPho chip 108 and the fiber optic cable 120 is expanded or compressed accordingly depending on the direction of propagation of the optical signal. In one example, the plurality of optical structures 110₁-110_{N} extending from the second interface 109 adjacent to the 9 μm fibers in the fiber connector 112 have transmission regions with cross-sectional areas that vary at different portions of the respective structures to facilitate coupling to the plurality of 1 micron waveguides in the SiPho chip 108. In some embodiments, the plurality of optical structures 110₁-110_{N} are tapered along at least a portion of their length from a 9 μm dimensional core size until they are near 1 μm dimensional core size near the first interface 107, where it is assumed that the varying dimensional core size relates to a dimension of a side of a square or rectangular cross-sectional shaped plurality of optical structure 110₁-110_{N}. In some embodiments, the tapered plurality of optical structures 110₁-110_{N} have a cross-sectional area ratio which, if measured at one end versus measured at the opposing end of the plurality of optical structures 110₁-110_{N}, is greater that 1:1 and less than about 1:100, or less than 1:81. In some embodiments, the plurality of optical structures 110₁-110_{N} extending from the second interface 109 adjacent to the fiber connector 112 have a varying refractive index along at least a portion of their length from the second interface 109 to the first interface 107 to facilitate coupling between the optical elements within the SiPho chip 108 and the fiber connector 112 that have different cross-sectional dimensions.

In another aspect, the photonic integrated interconnect unit 103 is configured such that the transmission loss of the optical signal between the first interface 107 and the second interface 109 is approximately or less than 3 dB, inclusive of loss due to the transmission of the optical signal through the plurality of optical structures 110₁-110_{N} themselves. In some embodiments, the transmission loss may largely be dependent on the coupling at the first interface 107 between the SiPho chip 108 and the plurality of optical structures 110₁-110_{N}.

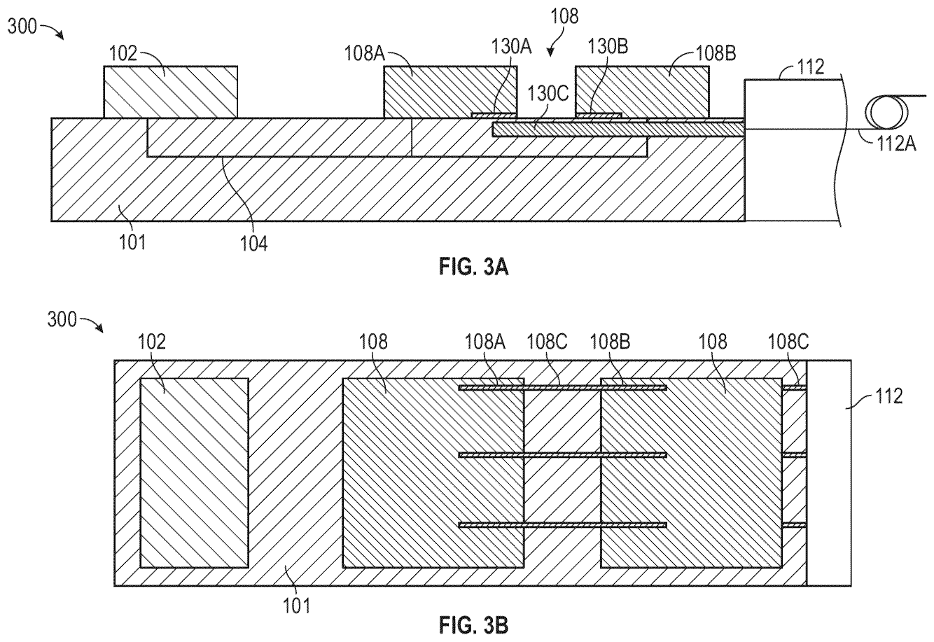

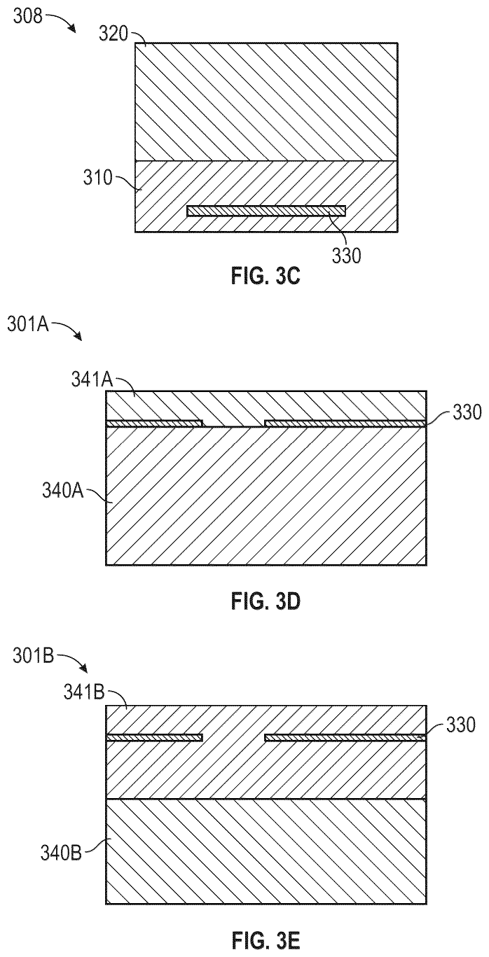

FIG. 3A illustrates a cross-sectional side view of the co-packaged optical and electrical device 300. FIG. 3B illustrates a top view of the co-packaged optical and electrical device 300. The SiPho chip 108 of the co-packaged optical and electrical device 300 includes a first photonics integrated circuit (PIC) 108A and a second PIC 108B. The electrical or opto-electrical chip 102 is connected to the first PIC 108A and the second PIC 108B via interconnects 104. The first PIC 108A includes a first waveguide 130A and the second PIC 108B includes a second waveguide 130B. In the illustrated embodiment, the plurality of optical structures 110₁-110_{N} includes a third waveguide 130C. The third waveguide 130C is formed on (e.g., directly or indirectly) or is integral with the package substrate 101.

The light being transmitted through the third waveguide 130C can be either received from the first waveguide 130A and second waveguide 130B or received from one or more of a plurality of optical fibers within the fiber connector 112 that a light signal source is in communication with during use. The SiPho chip 108 is typically configured to receive (e.g., detect) light transmitted through the third waveguide 130C and also emit (e.g., transmit) light into the third waveguide 130C in an effort to communicate with external devices connected through the fiber connector 112. The SiPho chip 108 can be configured to transmit light into the third waveguide 130C by waveguide-to-waveguide evanescent coupling with the first waveguide 130A and/or the second waveguide 130B.

The use of waveguide-to-waveguide evanescent coupling enables a reduction in the number of optical fibers within the fiber connector 112 by enabling the third waveguide 130C to couple to multiple PICs (e.g., the first PIC108A and the second PIC 108B) simultaneously. In addition, the waveguide-to-waveguide evanescent coupling enables the coupling of multiple waveguides with the SiPho chip 108 to substrate bonding, which reduces the light loss during the coupling caused by surface bow and warp. Further, the use of waveguide-to-waveguide evanescent coupling enables control of the coupling rate by changing the waveguide dimensions, the coupling length, or the gap between the waveguide (e.g., the gap between the first waveguide 130A and the third waveguide 130C). Alignment tolerance can be controlled by changing the spot size of the waveguide or by using complex waveguide structures.

FIG. 3C illustrates a photonic integrated circuit (PIC) 308. The PIC may be used as the first PIC 108A or the second PIC 108B. The PIC 308 includes a first layer 310 and a second layer 320. The first layer 310 of the PIC 308 includes a silicon oxide (SiOₓ), a metal (e.g., copper), silicon nitride (SiN), or a combination thereof. The second layer includes a silicon (Si), an amorphous silicon (a-Si), a metal (e.g., copper), lithium niobium oxide (LiNbOₓ), or a combination thereof. A waveguide 330 (e.g., the first waveguide 130A or second waveguide 130B) is disposed in the first layer of the PIC 308. The waveguide 330 includes a Si, an a-Si, a silicon nitride (SIN), a lithium niobium oxide (LiNbOₓ), or a combination thereof.

FIG. 3D illustrates a glass packaging substrate 301A. In the illustrated embodiment, the glass packaging substrate 301A of the co-packaged optical and electrical device 100 (which is applicable to other embodiments described herein) includes a first layer 340A and a second layer 341A. The first layer 340B includes a glass material. The first layer 340A has a thickness of about 50 micron to about 1000 micron, such as about 100 microns. The second layer 341B includes a silicon oxide (SiOₓ), a metal (e.g., copper), silicon nitride (SiN), or a combination thereof. The second layer 341A has a thickness of about 1 micron to about 20 microns, such as about 10 microns. A waveguide 330 (e.g., the third waveguide 130C) is disposed in the second layer 341A. In some embodiments, the waveguide 330 is disposed in the second layer 341A at the interface between the first layer 340A and the second layer 341A. The waveguide 330 includes a Si, an α-Si, a silicon nitride (SiN), an erbium doped SiN, lithium niobium oxide (LiNbOₓ), or a combination thereof.

FIG. 3E illustrates a silicon packaging substrate 301B. In the illustrated embodiment, the silicon packaging substrate 301B of the co-packaged optical and electrical device 100 (which is applicable to other embodiments described herein) includes a first layer 340B and a second layer 341B. The first layer 340B includes a Si material, an α-Si, a glass, or a combination thereof. The first layer 340B has a thickness of about 50 micron to about 150 micron, such as about 100 microns. The second layer 341B includes a silicon oxide (SiOₓ), a metal (e.g., copper), silicon nitride (SiN), or a combination thereof. The second layer 341B has a thickness of about 3 micron to about 20 microns. A waveguide 330 (e.g., the third waveguide 130C) is disposed in the second layer 341B. The waveguide 330 includes a Si, an α-Si, a silicon nitride (SiN), an erbium doped SiN, lithium niobium oxide (LiNbOₓ), or a combination thereof.

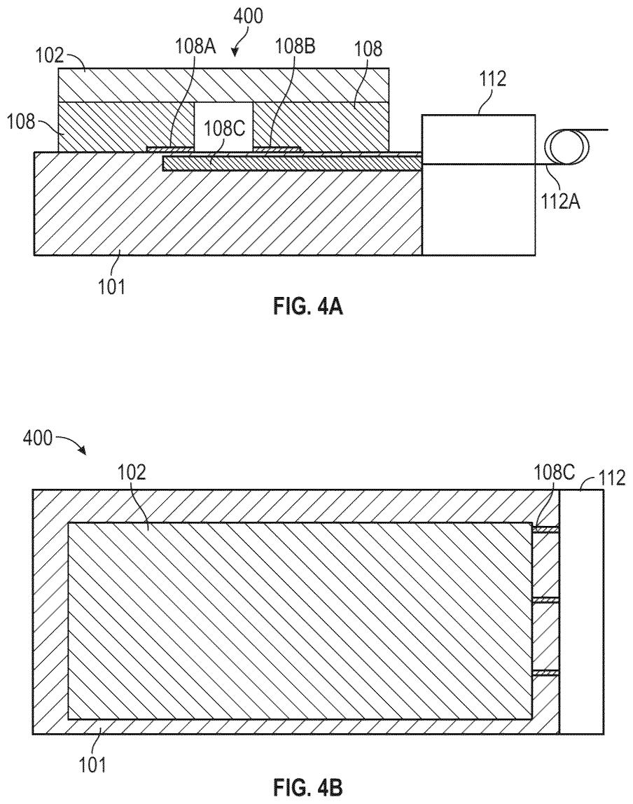

FIG. 4A illustrates a cross-sectional side view of the co-packaged optical and electrical device 400 with a top mounted electrical or opto-electrical chip 102. FIG. 4B illustrates a top view of the co-packaged optical and electrical device 400 with a top mounted electrical or opto-electrical chip 102. The electrical or opto-electrical chip 102 is connected to the first PIC 108A and the second PIC 108B via the electrical or opto-electrical chip 102 being mounted to the first PIC 108A and the second PIC 108B. The co-packaged optical and electrical device 400 enables the removal of interconnects 104 formed on or integral with the packaging substrate 101.

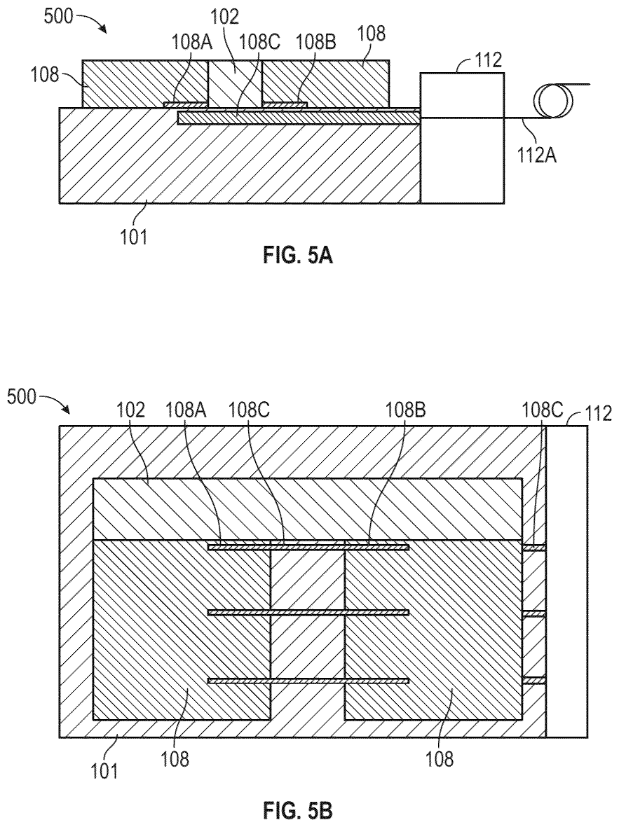

FIG. 5A illustrates a cross-sectional side view of the co-packaged optical and electrical device 500 with an integrated electrical or opto-electrical chip 102. FIG. 5B illustrates a top view of the co-packaged optical and electrical device 500 with an integrated electrical or opto-electrical chip 102. The electrical or opto-electrical chip 102 is connected to the first PIC 108A and the second PIC 108B via the electrical or opto-electrical chip 102 being monolithically integrated with the first PIC 108A and the second PIC 108B. The co-packaged optical and electrical device 400 enables the removal of interconnects 104 formed on or integral with the packaging substrate 101.

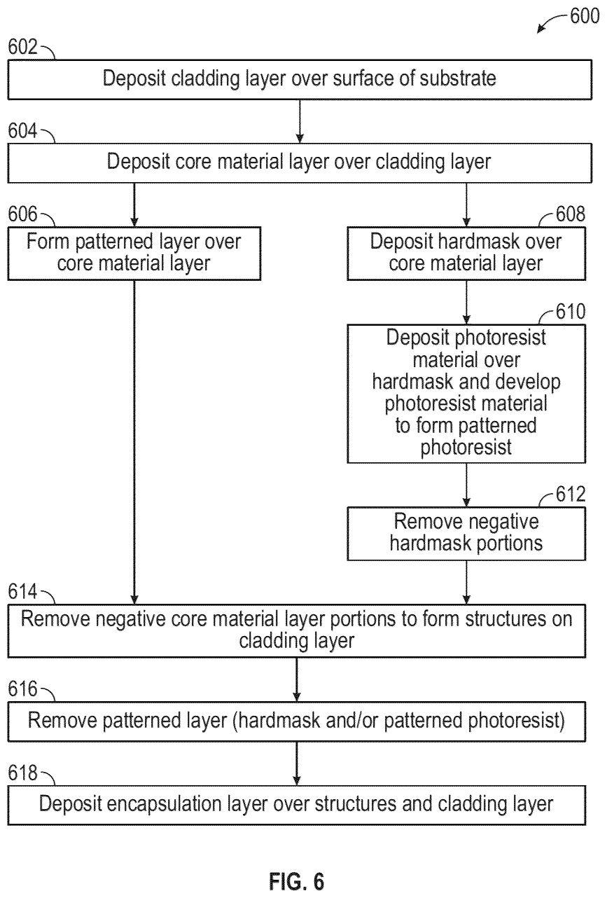

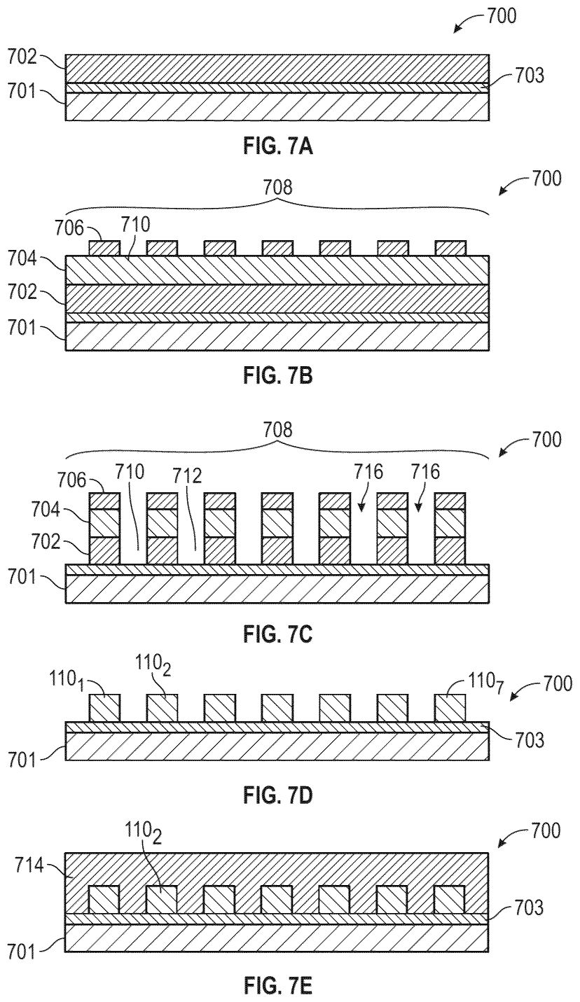

FIG. 6 is a flow diagram illustrating operations of a method 600 for fabricating a portion 700 of the packaging substrate 101, as shown in FIGS. 7A-7E, such as a portion of the plurality of optical structures 110₁-110_{N}. In some embodiments, the method 600 is a single substrate process or batch process involving a plurality of substrates that are fabricated simultaneously. At operation 602, as shown in FIG. 7A, a cladding layer 703 is disposed over a surface of a supporting substrate 701. The cladding layer 703 may be disposed over the surface using a liquid material pour casting process, a spin-on coating process, a liquid spray coating process, a dry powder coating process, a screen printing process, a doctor blading process, a PVD process, a CVD process, a PECVD process, a FCVD process, an ALD process, or an evaporation process. In some embodiments, the cladding layer 703 is made of a material having a refractive index that is relatively low, as compared to the refractive index of the core material layer 702, which is formed in a subsequent operation. In some embodiments, the cladding layer 703 has a refractive index between 1.3 and 1.5. In some embodiments, the cladding layer 703 employed at operation 602 can be formed from one or more low-index materials including Si₃N₄, SiO₂, doped SiO₂, low-index fluoropolymers, nanoparticle films, hydrogels, porous materials, and photoresist containing materials.

At operation 604, as shown in FIG. 7A, a core material layer 702 is disposed over the surface of cladding layer 703 and the supporting substrate 701. The core material layer 702 may be disposed over the surface of the cladding layer 703 using a liquid material pour casting process, a spin-on coating process, a liquid spray coating process, a dry powder coating process, a screen printing process, a doctor blading process, a PVD process, a CVD process, a PECVD process, a FCVD process, an ALD process, or an evaporation process. In some embodiments, the supporting substrate 701 includes a material selected from a group that consists of silica (SiO₂), boron oxide (B₂O₃), and alumina (Al₂O₃).

The core material layer 702 can be a low index of refraction material or a high index of refraction material, depending upon the embodiment. The material used to form the core material layer 702 has a refractive index different from the refractive index of the material used to form the cladding layer 703. In some embodiments, the core material layer 702 has a refractive index between 1.4 and 1.5. In another embodiment, the material used to form the core material layer 302 has a refractive index that is higher than the refractive index of the material used to form the cladding layer 703. In general, the refractive index of the core material layer 702 is different from the cladding layer 703 and the encapsulation layer 714. In some embodiments, the core material layer 702 has a refractive index between 1.45 and 1.50 while the cladding layer 703 and encapsulation layer 714 have refractive indices between 1.40 and 1.44.

In some embodiments, which can be combined with other embodiments described herein, the core material layer 702 can be formed from one or more materials including, without limitation, silicon carbide (SiC), silicon oxycarbide (SiOC), titanium dioxide (TiO₂), silicon dioxide (SiO₂), vanadium (IV) oxide (VOₓ), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium (IV) oxide (HfO₂), lithium niobate (LiNbO₃), silicon carbon-nitride (SiCN) containing materials or other material(s) suitable for the formation of optical structures.

At operation 606, a patterned layer is disposed over the core material layer 702. The patterned layer defines exposed negative portions of the core material layer 702 that, when removed, correspond to a structure pattern that will enable the formation of the plurality of optical structures 110₁-110_{N} in a subsequent operation.

In some embodiments, as shown in FIGS. 7B and 7C and described in further detail below in operations 608-612, disposing the patterned layer on the core material layer 702 may include disposing a hardmask 704 on the core material layer 702, disposing a patterned photoresist 706 on the hardmask 704, the patterned photoresist 706 defining exposed portions of the hardmask 704, and removing the exposed portions of the hardmask 704 to form a patterned hardmask 704 corresponding to the patterned photoresist 706.

In another embodiment, disposing the patterned layer on the core material layer 702 in operation 606 may include forming a patterned photoresist over the core material layer 702 by disposing a photoresist layer on the core material layer 702 and performing a lithography process to pattern and develop the photoresist material. The patterned photoresist defines exposed negative portions of the core material layer 702. The patterned photoresist would allow the selective etching of the core material layer 702 under the patterned photoresist, as the patterned photoresist protects certain regions of the core material layer 702 from unwanted etching in subsequent processes. In such embodiments, the method 600 continues with operation 614 to remove negative structure portions 712 of the core material layer 702 defined by the patterned layer.

In operation 608, as shown in FIG. 7B, the hardmask 704 is disposed over the core material layer 702. The hardmask 704 may be disposed over the core material layer 702 using a liquid material pour casting process, a spin-on coating process, a liquid spray coating process, a dry powder coating process, a screen printing process, a doctor blading process, a PVD process, a CVD process, a PECVD process, a FCVD process, an ALD process, or an evaporation process. The hardmask 704 can include, but is not limited to, a material selected from a group of chromium (Cr), silver (Ag), Si₃N₄, SiO₂, TIN, and carbon (C) containing materials.

At operation 610, as shown in FIG. 7B, the patterned photoresist 706 is disposed over the core material layer 702, and, when present, over the hardmask 704. The patterned photoresist 706 allows the selective etching of material under the patterned photoresist 706, since the patterned photoresist 706 protects certain regions from unwanted etching in subsequent processes. In one example, the patterned photoresist 706 is formed by disposing a photoresist material on the hardmask 704 and performing a lithography process to pattern and develop the photoresist material. The patterned photoresist 706 defines exposed portions 710 of the hardmask 704 (i.e., openings of the hardmask 704). The exposed portions 710 correspond to a pattern 708 that will be used to form the plurality of optical structures 110₁-110_{N}. The patterned photoresist 706 may be disposed on the hardmask 704 or on the core material layer 702 using a spin-on coating process. The photoresist material may include, but is not limited to, light-sensitive polymer containing materials.

At operation 612, as shown in FIG. 7C, the exposed portions 710 of the hardmask 704 are removed. Removing the hardmask portions 710 exposes negative structure portions 712 of the core material layer 702. The negative structure portions 712 correspond to the structure pattern 708 that will enable the formation of the plurality of optical structures 110₁-110_{N} in a subsequent operation. In some embodiments, the exposed portions 710 are removed by an ion etching, RIE, or selective wet chemical etching process to form a plurality of openings in the hardmask 704.

At operation 614, as shown in FIG. 7C, the negative structure portions 712 of the core material layer 702 are removed to form the plurality of optical structures 110₁-110_{N}. In various embodiments, which can be combined with other embodiments described herein, the negative structure portions 712 are removed by an ion etching, RIE, or selective wet chemical etching process to form a plurality of trenches 716 in the core material layer 702. In some embodiments, the removal of the exposed portions 710 in operation 612 and the etching of the negative structure portions 712 in operation 614 may be performed simultaneously or sequentially. In some embodiments, the hardmask 704 has a lower etch rate than the material of the core material layer 702.

At operation 616, the patterned layer is removed. Removing the patterned layer includes removing a hardmask and/or a photoresist layer. In the example shown in FIG. 7D, removing the patterned layer includes removing the hardmask 704 and the patterned photoresist 706. Removing the hardmask 704 may include ion etching, RIE, or selective wet chemical etching. Removing the patterned photoresist 706 may include the use of an ashing process or etching process described herein.

At operation 618, as shown in FIG. 7E, an encapsulation layer is disposed over the cladding layer 703 and the plurality of optical structures 110₁-110_{N}. The encapsulation layer 714 may be formed by use of one or more of PVD, CVD, FCVD, and spin-on coating processes. In some embodiments, the encapsulation layer 714 is made of a material having a refractive index that is relatively low, as compared to the refractive index of the core material layer 702. In some embodiments, the encapsulation layer 714 has a refractive index between 1.3 and 1.5, such as between 1.40 and 1.44. In some embodiments, more than one encapsulation layer can be used having more than one index of refraction.

In an embodiment, which can be combined with other embodiments herein, the encapsulation layer 714 can be formed from one or more low-index materials including Si₃N₄, SiO₂, doped SiO₂, low-index fluoropolymers, nanoparticle films, hydrogels, porous materials, and photoresist containing materials. The material used to form the encapsulation layer 714 has a refractive index different from the refractive index of the material used to form the core material layer 702. In some embodiments, the material used to form the encapsulation layer 714 has a refractive index lower than the refractive index of the material used to form the core material layer 702. Low-index materials are discussed herein in contrast to “high” index materials such as amorphous and crystalline silicon, silicon nitride, titanium dioxide, gallium phosphide, tantalum pentoxide, gallium nitride, sulfur-inated materials, polymers, and other materials with appropriate optical properties. It is contemplated that materials and combinations of materials can be used to form the cladding layer 703, encapsulation layer 714 and/or the core material layer 702 discussed herein, and that these materials can be selected based on the targeted optical properties of the optical device(s) fabricated in the method 600.

In another embodiment, which can be combined with other embodiments herein, the encapsulation layer 714 can be formed to include an interlayer (not shown) that extends above a top surface of the encapsulation layer 714. The interlayer may be used to separate the encapsulation layer 714 and the plurality of optical structures 110₁-110_{N} formed from the core material layer 702 from additional optical structures of a second optical structure material layer (not shown). Thus, optical structures of additional different optical layers may be formed and layered on top off the portion 700 shown in FIG. 7E while not being in direct contact with the plurality of optical structures 110₁-110_{N} or the encapsulation layer 714. Furthermore, the lower the refractive index of the material used for encapsulation, the lower the aspect ratio of the constituent nanostructures (features patterned) for each optical structure. In an embodiment, lower aspect ratio features produce thinner optical layers, as well as faster and cleaner etching. Thus, the systems and methods herein result in more efficient fabrication processes in terms of time, cost, and complexities.

While the plurality of optical structures 110₁-110_{N} illustrated herein in FIGS. 7A-7E are shown as having approximately square or rectangular-shaped cross-sections, it is contemplated that the optical structures can, in other examples, include tapered sidewalls and thus form a trapezoidal cross-section (not pictured). In one example, the trapezoidal cross-section is wider near the top versus the bottom of the opening.

Therefore, the method 600 can be used to form the optical structures 110₁-110_{N}, which include the remaining portions of the core material layer 702, by use of a negative pattering process. As illustrated in FIG. 7E, the package substrate 101 includes seven optical structures (i.e., optical structures 110₁-110₇) that are disposed on the supporting substrate 701 and are each encapsulated and separated by at least a portion of the encapsulation layer 714.

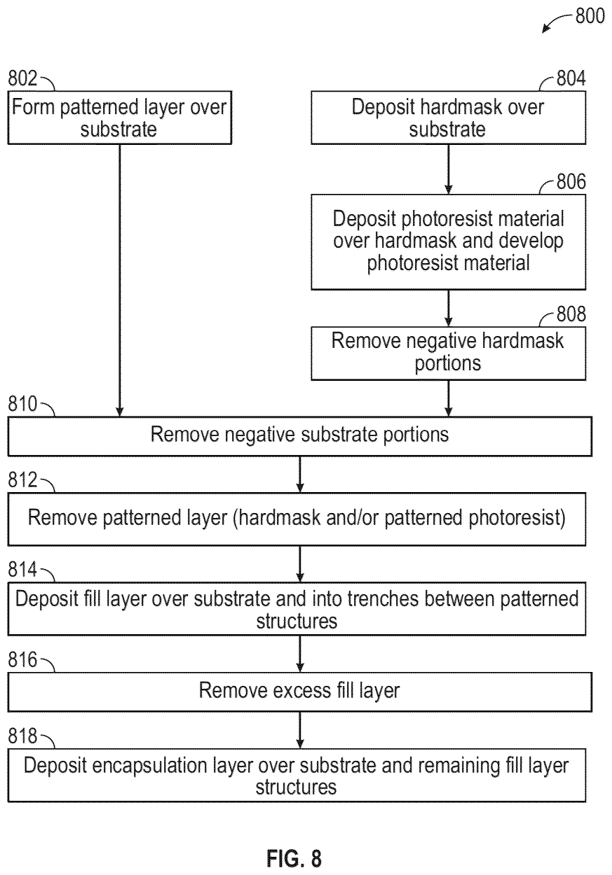

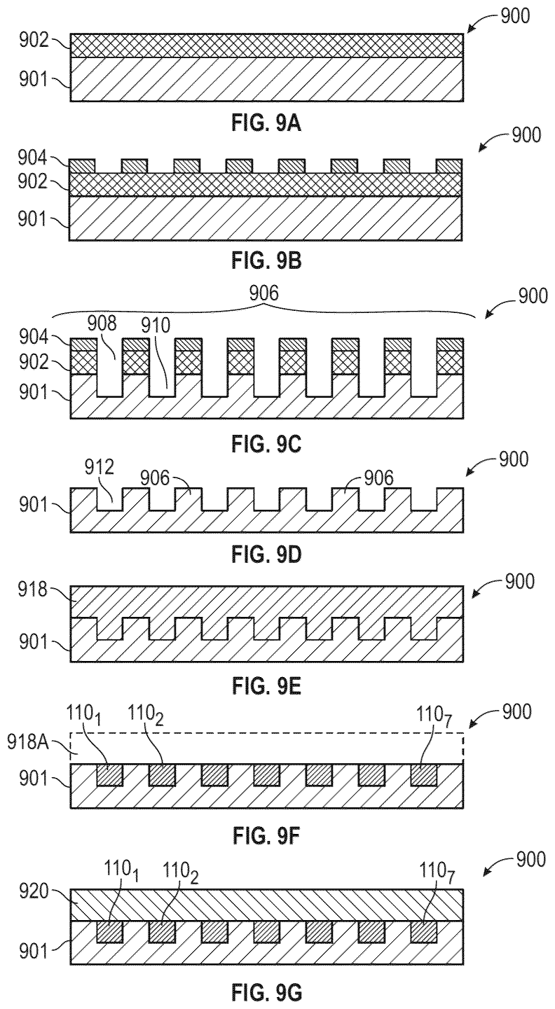

FIG. 8 illustrates a flow diagram illustrating operations of another method 800 for fabricating a portion 900 of the package substrate 101, as shown in FIGS. 9A-9F, such as a portion of the optical structures 110₁-110_{N}. The method 800 can include operations 802-818. The method 800 begins in operation 802 with a patterned layer disposed over the supporting substrate 901. The patterned layer defines exposed negative portions of the supporting substrate 901 that, when removed, correspond to a structure pattern that will enable the formation of the plurality of optical structures 110₁-110_{N} in a subsequent operation.

In an embodiment, as shown in FIGS. 9B and 9C and described in further detail below in operations 904-908, disposing the patterned layer on the supporting substrate 901 may include disposing a hardmask 902 on the supporting substrate 901, disposing a patterned photoresist 904 on the hardmask 902, the patterned photoresist 904 defining exposed portions of the hardmask 902, and removing the exposed portions of the hardmask 902 to form a patterned hardmask 902 corresponding to the patterned photoresist 904.

In another embodiment, disposing the patterned layer on the supporting substrate 901 in operation 802 may include either directly disposing a patterned photoresist over the supporting substrate 901 or disposing a photoresist layer on the supporting substrate 901 and performing a lithography process to pattern and develop the photoresist material. The patterned photoresist defines exposed negative portions of the supporting substrate 901. The patterned photoresist would allow the selective etching of the supporting substrate 901 under the patterned photoresist, as the patterned photoresist protects certain regions of the supporting substrate 901 from unwanted etching in subsequent processes. In such embodiments, the method 800 continues with operation 810 below to remove negative structure portions 910 of the supporting substrate 901 defined by the patterned layer.

At operation 804, as shown in FIG. 9A, the hardmask 902 is disposed over the supporting substrate 901. The hardmask 902 may be disposed over the supporting substrate 901 using a liquid material pour casting process, a spin-on coating process, a liquid spray coating process, a dry powder coating process, a screen printing process, a doctor blading process, a PVD process, a CVD process, a PECVD process, a FCVD process, an ALD process, or an evaporation process. The hardmask 902 can include, but is not limited to, a material selected from a group of chromium (Cr), silver (Ag), Si₃N₄, SiO₂, TiN, and carbon (C) containing materials. In some embodiments, the supporting substrate 901 includes a material selected from a group that consists of silica (SiO₂), boron oxide (B₂O₃), and alumina (Al₂O₃).

At operation 806, the patterned photoresist 904 is disposed over the supporting substrate 901, and, when present, also over the hardmask 902, as shown in FIG. 9B. The patterned photoresist 904 allows the selective etching of material under the patterned photoresist 904, as the patterned photoresist 904 protects certain regions from unwanted etching in subsequent processes. In one example, the patterned photoresist 904 is formed by disposing a photoresist material on the hardmask 902 and performing a lithography process to pattern and develop the photoresist material. The patterned photoresist 904 defines exposed portions 908 of the hardmask 902 (i.e., openings of the hardmask 902). The exposed portions 908 correspond to a structure pattern 906 to result in the formation of the plurality of optical structures 110₁-110_{N}. In one example, the patterned photoresist 904 may be disposed on the hardmask 902 using a spin-on coating process. The photoresist material may include, but is not limited to, light-sensitive polymer containing materials.

At operation 808, as shown in FIG. 9C, the exposed portions 908 of the hardmask 902 are removed. Removing the exposed portions 908 exposes negative structure portions 910 of the supporting substrate 901. The negative structure portions 910 correspond to the structure pattern 906 to result in the formation of the plurality of optical structures 110₁-110_{N}. In some embodiments, the exposed portions 908 are removed by an ion etching, RIE, or selective wet chemical etching process to form a plurality of openings in the hardmask 902.

At operation 810, as shown in FIG. 9C, the negative structure portions 910 of the supporting substrate 901 are removed to form the structure pattern 906. In various embodiments, which can be combined with other embodiments described herein, the negative structure portions 910 of the supporting substrate 901 may be removed by an ion etching, RIE, or selective wet chemical etching process to form a plurality of trenches 912 in the supporting substrate 901. In some embodiments, the removal of the exposed portions 908 in operation 808 and portions of the supporting substrate 901 in operation 812 may be performed simultaneously or sequentially. In one aspect, the hardmask 902 has a lower etch rate than the material of the supporting substrate 901.

At operation 812, the patterned layer is removed. Removing the patterned layer may include removing a hardmask and/or a photoresist layer. In the example shown in FIG. 9D, removing the patterned layer includes removing the hardmask 902 and the patterned photoresist 904, thereby leaving the supporting substrate 901 with the plurality of structure pattern 906 each separated by the plurality of trenches 912. In an embodiment, removing the hardmask 902 may include ion etching, RIE, or selective wet chemical etching. Removing the patterned photoresist 904 may include a conventional ashing process or etching process.

At operation 814, as shown in FIG. 9E, a fill layer 918 is disposed over the supporting substrate 901 and the structure pattern 906 formed therein. The fill layer 918 can include, but is not limited to, a material selected from a group of Si₃N₄, SiO₂, low-index fluoropolymers, hydrogels, and photoresist containing materials. The fill layer 918 may be disposed over the supporting substrate 901 and into the plurality of trenches 912 by one or more of PVD, CVD, FCVD, and spin-on coating processes. The flowable nature of the fill layer 918 allows for the fill layer 918 to also flow into each of the plurality of trenches 912.

In some embodiments, the fill layer 918 is formed from material having a refractive index different from the refractive index of the package substrate 101 in the supporting substrate 901. In some embodiments, the fill layer 918 has a refractive index between 1.4 and 1.5. In another embodiment, the fill layer 918 is formed from material having a refractive index greater than the refractive index of the supporting substrate 901. In certain embodiments, the fill layer 918 may formed from a high-index material such as amorphous and crystalline silicon, silicon nitride, titanium dioxide, gallium phosphide, tantalum pentoxide, gallium nitride, sulfur-inated materials, polymers, and other materials with appropriate optical properties. It is contemplated that materials and combinations of materials can be used to form the fill layer 918 discussed herein, and that these materials can be selected based on the targeted optical properties of the optical device(s) fabricated in the method 800. In one example, the fill layer 918 has a refractive index between 1.45 and 1.50 while the supporting substrate 901 has a smaller refractive index between 1.40 and 1.44.

At operation 816, as shown in FIG. 9F, an excess fill layer portion 918A is removed, such that the height of the fill layer 918 within the plurality of trenches 912 is approximately the same height as the structure pattern 906 of the supporting substrate 901. The excess fill layer portion 918A may be removed using a chemical mechanical polishing (CMP) process, according to some embodiments. The removal of the excess fill layer 918 forms the plurality of plurality of optical structures 110₁-110_{N} in the substrate 901 separated by the structure pattern 906.

While the plurality of optical structures 110₁-110_{N} illustrated herein in FIGS. 9A-9F are shown as having approximately square or rectangular-shaped cross-sections, it is contemplated that the optical structures can, in other examples, include tapered sidewalls and thus form a trapezoidal cross-section (not pictured). In one example, the trapezoidal cross-section is wider near the top versus the bottom of the opening.

At operation 818, as shown in FIG. 9G, an encapsulation layer 920 is optionally disposed over the supporting substrate 901 and the plurality of optical structures 110₁-110_{N}. The encapsulation layer 920 may be formed by use of one or more of PVD, CVD, FCVD, and spin-on coating processes. In some embodiments, the encapsulation layer 920 is made of low-index of refraction material, as compared to the refractive index of the fill layer 918. In some embodiments, the encapsulation layer 920 has a refractive index between 1.3 and 1.9, such as between 1.40 and 1.44.

Therefore, the method 800 can be used to form the optical structures 110₁-110_{N}, which include the remaining portions of the fill layer 918, by use of a negative pattering process. As illustrated in FIGS. 9F and 9G, the package substrate 101 includes seven optical structures (i.e., optical structures 110₁-110₇) that include the portions of the fill layer 918 that are disposed within the supporting substrate 901, and thus are separated by portions of the supporting substrate 901.

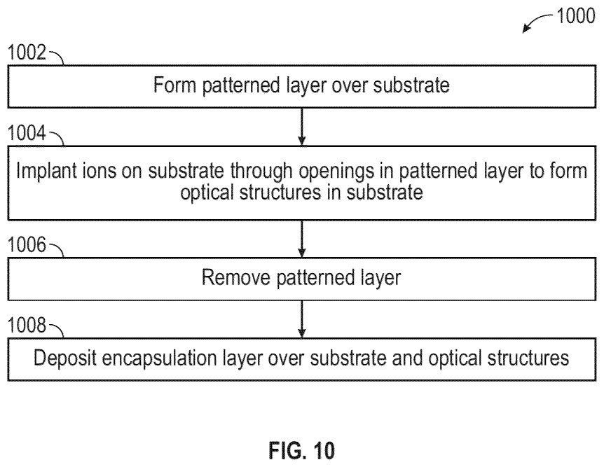

FIG. 10 illustrates a flow diagram illustrating operations of a method 1000 for fabricating a portion 1100 of the package substrate 101, as shown in FIGS. 10A-10E, such as a portion of the optical structures 110₁-110_{N}. The method 1000 includes operations 1102-1108. Method 1000 provides for depositing species of a refractive index changing material into a portion of a supporting substrate 1101 via an ion implantation process. Ion implantation is a surface modification technique capable of modifying the optical properties of a portion of a surface layer of the supporting substrate 1101. Ion implantation allows accurate control of both dopant composition and penetration depth through the choice of the species and the energy of the doping ions. In some embodiments, the supporting substrate 110₁ includes a material selected from a group that consists of silica (SiO₂), boron oxide (B₂O₃), and alumina (Al₂O₃).

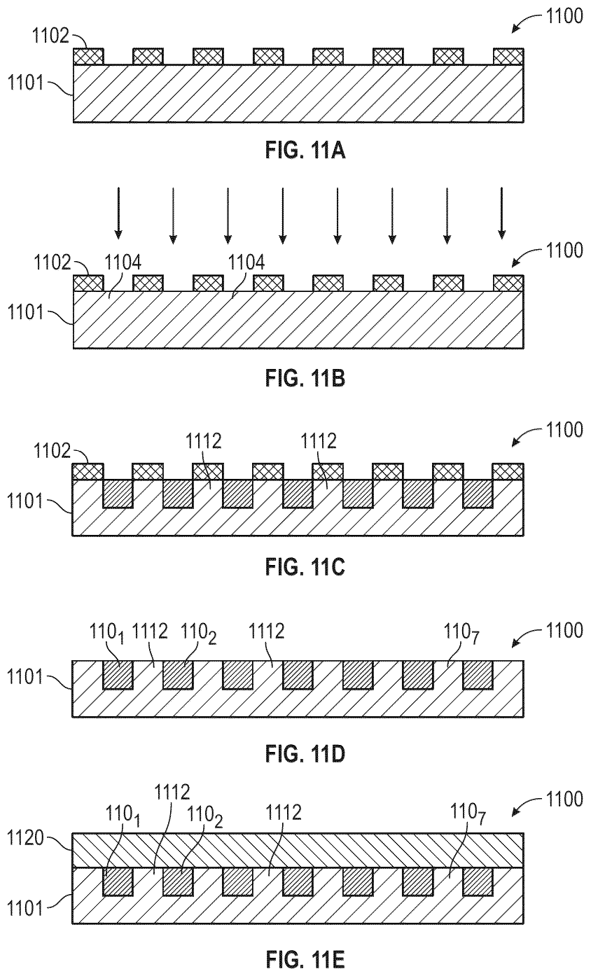

At operation 1002, as shown in FIG. 11A, a patterned layer 1102 is disposed over the supporting substrate 1101. The patterned layer 1102 defines exposed substrate portions 1104 of the supporting substrate 1101 (i.e., openings of the patterned layer 1102). The patterned layer 1102 is configured to allow the selective implantation of doping ions into the supporting substrate 1101 disposed under the patterned layer 1102, as portions of the patterned layer 1102 are able to function as a mask to block the doping ions from reaching selected portions of the supporting substrate 1101 under the patterned layer 1102.

The patterned layer 1102 can be a patterned photoresist or a patterned hardmask. In an embodiment, the patterned layer 1102 may be a patterned photoresist formed from materials including, without limitation, such as polymeric materials formed from phenol-, epoxy- or acrylic-resins. The patterned photoresist must be thick enough to reliably absorb the ions at these sites. Accordingly, it will generally be necessary for the resist film thickness to be appropriately selected as the ion energy of the implant process is adjusted. In one example, the patterned layer 1102 may be formed by disposing a photoresist material on the substrate 110₁ and performing a lithography process to pattern and develop the photoresist material. In another embodiment, the patterned layer 1102 may be a patterned hardmask. The hardmask can include, but is not limited to, a material selected from a group of chromium (Cr), silver (Ag), Si₃N₄, SiO₂, TIN, and carbon (C) containing materials.

At operation 1004, as shown in FIG. 11B, an ion implantation process is performed on the supporting substrate 1101. In the ion implantation process, doping ions are accelerated and implanted within the supporting substrate 1101 through the openings in the patterned layer 1102. The doping ions will include a dopant material that will alter the refractive index of the implanted regions positioned within the openings in the patterned layer 1102, and may include at least one of Al, P, F, Cl, P, or gases N, Ar or Kr. As described herein, the doping ions provided in the ion implantation process are generated from a plasma formed by applying a high voltage RF to a processing region of a plasma processing chamber. The plasma dissociated ions are then biased toward the surface of package substrate 101 and implanted a certain desired depth from the substrate surface. Once implanted, the doping ions bond with portions of the material in the supporting substrate 1101 and induce refractive index modifications in these portions of the package substrate 101. In some embodiments, when performing the ion implantation process within method 1000, the supporting substrate 1101 is placed on a substrate supporting pedestal of a plasma processing chamber, a gas is flowed into the interior of the plasma processing chamber and ignited to generate a plasma. A bias is then applied to the supporting substrate 1101 to accelerate the doping ions generated in the plasma towards a surface of the supporting substrate 1101. As a result of the plasma and the biasing of the supporting substrate 1101, the doping ions generated in the plasma are implanted into the supporting substrate 1101 to form a portion of the supporting substrate 1101. One example of the ion implantation apparatus is the Varian VIISTA® Trident, available from Applied Materials, Inc., Santa Clara, Calif.

In some embodiments, as shown in FIG. 11C, the ion implantation process employed in operation 1004 modifies the exposed substrate portions 1104 of the supporting substrate 1101 to form the plurality of optical structures 110₁-110_{N}. On the other hand, substrate regions 1112 protected by the patterned layer 1102 are not modified by the ion implantation process. In one aspect, the modification by the ion implantation depends on the ions (light ions or heavy ions) implanted in the package substrate 101. The ions implanted in the exposed portions 1104 of the package substrate 101 may be modified to have an increase in refractive index or decrease in refractive index. In some embodiments, the plurality of optical structures 110₁-110_{N} formed from the ion implantation process comprise a refractive index higher than the refractive index of the package substrate 101 and protected regions 1112.

At operation 1006, as shown in FIG. 11D, the patterned layer 1102 is removed thereby forming a package substrate 101 that includes the supporting substrate 110₁ that has an alternating plurality of optical structures 110₁-110_{N} and substrate regions 1112 formed therein. Removing the patterned layer 1102 may include removing a patterned hardmask or a patterned photoresist. Removing the patterned hardmask may include ion etching, RIE, or selective wet chemical etching. Removing the patterned photoresist may include the use of an ashing process or etching process described herein.

In some embodiments, it may be desirable to perform an annealing process on the package substrate 101 of substrate 110₁ to activate dopant species and to remove any damage created in the plurality of optical structures 110₁-110_{N} by the implantation process and/or better distribute the index of refraction altering dopant materials implanted during operation 1004 of the method 1000.

While the plurality of optical structures 110₁-110_{N} illustrated herein in FIGS. 11A-11E are shown as having approximately square or rectangular-shaped cross-sections, it is contemplated that the optical structures can, in other examples, include tapered sidewalls and thus form a trapezoidal cross-section (not pictured). In one example, the trapezoidal cross-section is wider near the top versus the bottom of the opening.

At operation 1008, as shown in FIG. 11E, an encapsulation layer 1120 is optionally disposed over the substrate 110₁ and the plurality of optical structures 110₁-110_{N}. The encapsulation layer 1120 may be formed by use of one or more of PVD, CVD, FCVD, and spin-on coating processes. In some embodiments, the encapsulation layer 1120 is made of low-index of refraction material having a refractive index lower than the refractive index of the implanted portions of the supporting substrate 1101. In some embodiments, the encapsulation layer 1120 has a refractive index between 1.3 and 1.9, such as between 1.40 and 1.44.

Therefore, the method 1000 can be used to form the optical structures 110₁-110_{N}, which include the implanted portions of the supporting substrate 1101, by use of a negative pattering and implantation process. As illustrated in FIG. 11E, the package substrate 101 includes seven optical structures (i.e., optical structures 110₁-110₇) that comprise the exposed portions 1104 that are formed within the supporting substrate 1101.

In summation, a co-packaged electrical or optical device is disclosed herein. A plurality of optical structures and SiPho chip 108 are formed integral with or mounted on the package substrate, which enables the removal of a silicon (Si) interposer commonly used in co-packaged optical and electrical devices. Removing the Si interposer simplifies manufacturing and reduces warp or bow associated with chip-to-substrate bonding, as a bond (i.e., the bond between the Si interposer and the package substrate) is eliminated. Furthermore, the Si interposer is an expensive and low yield component, requiring the formation of vias and substrate thinning, further increasing cost. A photonic integrated interconnect unit disposed on the package substrate, a plurality of interconnects, and the plurality of optical structures. The photonic integrated interconnect unit includes a photonic integrated circuit (PIC) including a PIC waveguide. The plurality of interconnects connect the electrical or opto-electrical chip to the photonic integrated interconnect unit. The interconnects are formed on or in the package substrate. The plurality of optical structures are configured to connect the photonic integrated interconnect unit to a fiber optic cable. The plurality of optical structures include a substrate waveguide formed on or in the package substrate. The substrate waveguide is coupled to the PIC waveguide via evanescent coupling. The waveguide-to-waveguide evanescent coupling enables the coupling of multiple waveguides with the SiPho chip to substrate bonding, which reduces the light loss during the coupling caused by surface bow and warp. Further, the use of waveguide-to-waveguide evanescent coupling enables control of the coupling rate by changing the waveguide dimensions, the coupling length, or the gap between the waveguide (e.g., the gap between the first waveguide and the third waveguide). Alignment tolerance can be controlled by changing the spot size of the waveguide or by using complex waveguide structures.

While the foregoing is directed to embodiments of the present disclosure, other and further embodiments of the disclosure may be devised without departing from the basic scope thereof, and the scope thereof is determined by the claims that follow.

What is claimed is:

1. A co-packaged optical and electrical device, comprising:
a package substrate;
an electrical or opto-electrical chip disposed on the package substrate;
a photonic integrated interconnect unit disposed on the package substrate, comprising:
a photonic integrated circuit (PIC) comprising a PIC waveguide;
a plurality of interconnects connecting the electrical or opto-electrical chip to the photonic integrated interconnect unit, wherein the interconnects are formed on or in the package substrate; and
a plurality of optical structures configured to connect the photonic integrated interconnect unit to a fiber optic cable, the plurality of optical structures comprising:
a substrate waveguide formed on or in the package substrate, wherein the substrate waveguide is coupled to the PIC waveguide via evanescent coupling.

2. The co-packaged optical and electrical device of claim 1, further comprising:
a printed circuit board (PCB), wherein the package substrate is disposed on the PCB.

3. The co-packaged optical and electrical device of claim 1, wherein the PIC comprises:
a first layer; and
a second layer.

4. The co-packaged optical and electrical device of claim 3, wherein:
the first layer comprises a silicon oxide (SiOₓ), a copper, silicon nitride (SIN), or a combination thereof; and
the second layer comprises a silicon (Si), an amorphous silicon (α-Si), a metal, or a combination thereof.

5. The co-packaged optical and electrical device of claim 1, wherein the package substrate is a glass substrate, comprising:
a first layer comprising a glass material; and
a second layer comprising a silicon oxide (SiOₓ), a copper, silicon nitride (SiN), or a combination thereof.

6. The co-packaged optical and electrical device of claim 5, wherein:
the first layer has a thickness of about 50 microns to about 1000 microns; and
the second layer has a thickness of about 1 micron to about 20 microns.

7. The co-packaged optical and electrical device of claim 1, wherein the package substrate is a silicon substrate, comprising:
a first layer comprising a Si material, an α-Si, a metal, or a combination thereof; and
a second layer comprising a silicon oxide (SiOₓ), a copper, silicon nitride (SiN), or a combination thereof.

8. The co-packaged optical and electrical device of claim 7, wherein:
the first layer has a thickness of about 50 microns to about 150 microns; and
the second layer has a thickness of about 3 microns to about 20 microns.

9. A co-packaged optical and electrical device, comprising:
a package substrate;
an integrated electrical or opto-electrical chip disposed on the package substrate, comprising:
an electrical or opto-electrical chip disposed on the package substrate; and
a photonic integrated interconnect unit disposed on the package substrate, comprising:
a first photonic integrated circuit (PIC) comprising a first PIC waveguide;
a second PIC comprising a second PIC waveguide; and
a plurality of optical structures configured to connect the photonic integrated interconnect unit to a fiber optic cable, the plurality of optical structures comprising:
a substrate waveguide formed on or in the package substrate, wherein the substrate waveguide is coupled to the first PIC waveguide and the second PIC waveguide via evanescent coupling.

10. The co-packaged optical and electrical device of claim 9, wherein the package substrate is a glass substrate, comprising:
a first layer comprising a glass material; and
a second layer comprising a silicon oxide (SiOₓ), a copper, silicon nitride (SiN), or a combination thereof.

11. The co-packaged optical and electrical device of claim 10, wherein:
the first layer has a thickness of about 50 microns to about 100 microns; and
the second layer has a thickness of about 1 micron to about 20 microns.

12. The co-packaged optical and electrical device of claim 9, wherein the package substrate is a silicon substrate, comprising:
a first layer comprising a Si material, an α-Si, a copper or a combination thereof; and
a second layer comprising a silicon oxide (SiOₓ), a copper, silicon nitride (SiN), or a combination thereof.

13. The co-packaged optical and electrical device of claim 12, wherein:
the first layer has a thickness of about 50 microns to about 150 microns; and
the second layer has a thickness of about 3 microns to about 20 microns.

14. A co-packaged optical and electrical device, comprising:
a package substrate;
a photonic integrated interconnect unit disposed on the package substrate, comprising:
a photonic integrated circuit (PIC) comprising a PIC waveguide, wherein the PIC waveguide is disposed in the PIC;
an electrical or opto-electrical chip disposed on the photonic integrated interconnect unit; and
a plurality of optical structures configured to connect the photonic integrated interconnect unit to a fiber cable, the plurality of optical structures comprising:
a substrate waveguide formed on or in the package substrate, wherein the substrate waveguide is coupled to the PIC waveguide via evanescent coupling.

15. The co-packaged optical and electrical device of claim 14, wherein the PIC comprises:
a first layer; and
a second layer.

16. The co-packaged optical and electrical device of claim 15, wherein:
the first layer comprises a silicon oxide (SiOₓ), a copper, silicon nitride (SIN), or a combination thereof; and
the second layer comprises a silicon (Si), an amorphous silicon (α-Si), a copper or a combination thereof.

17. The co-packaged optical and electrical device of claim 14, wherein the package substrate is a glass substrate, comprising:
a first layer comprising a glass material; and
a second layer comprising a silicon oxide (SiOₓ), a copper, silicon nitride (SiN), or a combination thereof.

18. The co-packaged optical and electrical device of claim 17, wherein:
the first layer has a thickness of about 50 microns to about 1000 microns; and
the second layer has a thickness of about 1 micron to about 20 microns.

19. The co-packaged optical and electrical device of claim 14, wherein the package substrate is a silicon substrate, comprising:
a first layer comprising a Si material, an α-Si, a copper or a combination thereof; and
a second layer comprising a silicon oxide (SiOₓ), a copper, silicon nitride (SiN), or a combination thereof.

20. The co-packaged optical and electrical device of claim 19, wherein:
the first layer has a thickness of about 50 microns to about 150 microns; and
the second layer has a thickness of about 3 microns to about 20 microns.
